(19) United States
(12) Patent Application Publication
(10) Pub. No.: US 2016/0034843 A1
(43) Pub. Date: Feb. 4, 2016

(54) INVENTORY AND QUEUE MANAGEMENT

(71) Applicant: Apple Inc., Cupertino, CA (US)

(72) Inventors: Christopher R. Costello, San Jose, CA (US); Kevin M. Wright, San Jose, CA (US); Kimberly C. Baum-McKinnon, Alameda, CA (US); Terri A. Haeberle, San Jose, CA (US)

(21) Appl. No.: 14/447,224

(22) Filed: Jul. 30, 2014

(51) Int. Cl. G06Q 10/06; G06Q 10/08

(52) U.S. Cl. CPC G06Q 10/063114; G06Q 10/087

(57) ABSTRACT

Disclosed herein are systems, methods, and non-transitory computer-readable storage media for providing customers in a queue with assurance that the product that they queued up to purchase will be reserved for them and for providing customer with a digital queue card that provides information relating to the customers' spot in line, a dynamic estimated wait time, and tools for expediting their checkout process and the overall wait time for all the customers in the queue.

### BACKGROUND

1. Technical Field

The present disclosure relates to retail sales and more specifically to inventory and queue management.

2. Introduction

Existing inventory management solutions are not adequate to provide assurance to customers in a very long queue that their desired product(s) will be available after waiting in the queue. For example, typical inventory management solutions merely track products and providing notice to managers when it is time to re-order more products. However, in the case of a very long queue with limited inventory (e.g. product launch event, midnight release, etc.), these existing solutions are inadequate to give customers assurance that, even after an hours-long wait, that the exact product that they desire will be available.

Likewise, existing queue management solutions are inadequate. Typically, queue management involves handing out paper tickets that are used for ordering a queue. However, this approach can lead to counterfeiting fake tickets get a better space in the queue or using a ticket from a first retail location at another retail location.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for providing customers in a queue with assurance that the product that they queued up to purchase will be reserved for them and for providing customer with a digital queue card that provides information relating to the customers' spot in line, a dynamic estimated wait time, and tools for expediting their checkout process and the overall wait time for all the customers in the queue.

Some embodiments of the present technology involve a retail employee gathering information about customers in a queue using a portable electronic device. The customer information can include a description of the product(s) that the customer wants. The employee can send the information, using the portable electronic device, to an inventory and queue management system. The inventory and queue management system can use the product information specified to reserve the desired product(s) in the inventory management system. The inventory and queue management system can also reserve product(s) ordered or reserved by online customers, thereby preventing online orders to affect the availability of products for the customer in the queue.

The inventory and queue management system can also assign the customer a spot in the queue and provide the customer access to a digital queue card containing information about the customer's spot in the queue, an estimated wait time, an estimated checkout time, and tools for expediting the checkout process. The tools for expediting the checkout process can include tools for verifying an account with a cellular carrier for determining whether the selected products are eligible with the carrier, tools for beginning a process of porting a phone number from an existing device to the selected new device, tools for specifying whether the new product will replace an existing product, and tools for backing up an existing product in advance of replacing it with a new product. In some embodiments, the digital queue card can include a link to a network storage platform for backing up data on an electronic device.

The expediting tools can be used to decrease the checkout time for individual customers and also the wait time for the rest of the customers in the queue. In some cases, the inventory and queue management system can encourage use of the expediting tools by sending promotions to customers that use the expediting tools. Also, as customers use the expediting tools, the estimated wait time for the rest of the customers in the queue decreases. In some cases, as an estimated wait time drops, the inventory and queue management system can send notifications to the customer in the queue to provide an updated estimated wait time.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a system for managing a queue and managing an inventory according to some embodiments of the present technology;

FIG. 2 illustrates an example of a method of managing a queue and managing an inventory system according to some embodiments of the present technology;

FIGS. 3A-3C illustrate examples of interface tools for gathering customer information and creating a reservation in a retail inventory system according to some embodiments of the present technology;

FIG. 4A illustrates an exemplary message sent to a customer by an inventory and queue management engine;

FIG. 4B illustrates an example of a browser-based digital queue card according to some embodiments of the present technology;

FIG. 4C illustrates an example of a digital queue card in a digital wallet application according to some embodiments of the present technology;

FIG. 4D illustrates a notification appearing on the lock screen according to some embodiments of the present technology;

FIGS. 5A-5F illustrate examples of expediting tools according to some embodiments of the present technology;

FIG. 6A and FIG. 6B illustrate exemplary possible system embodiments; and

FIG. 7 illustrates an exemplary cloud computing system configuration.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

A system, method and non-transitory computer-readable media are disclosed which provides customers in a queue with assurance that the product that they queued up to purchase will be reserved for them and which provides customers with a digital queue card that provides information relating to the customers' spot in line, a dynamic estimated wait time, and tools for expediting their checkout process and the overall wait time for all the customers in the queue.

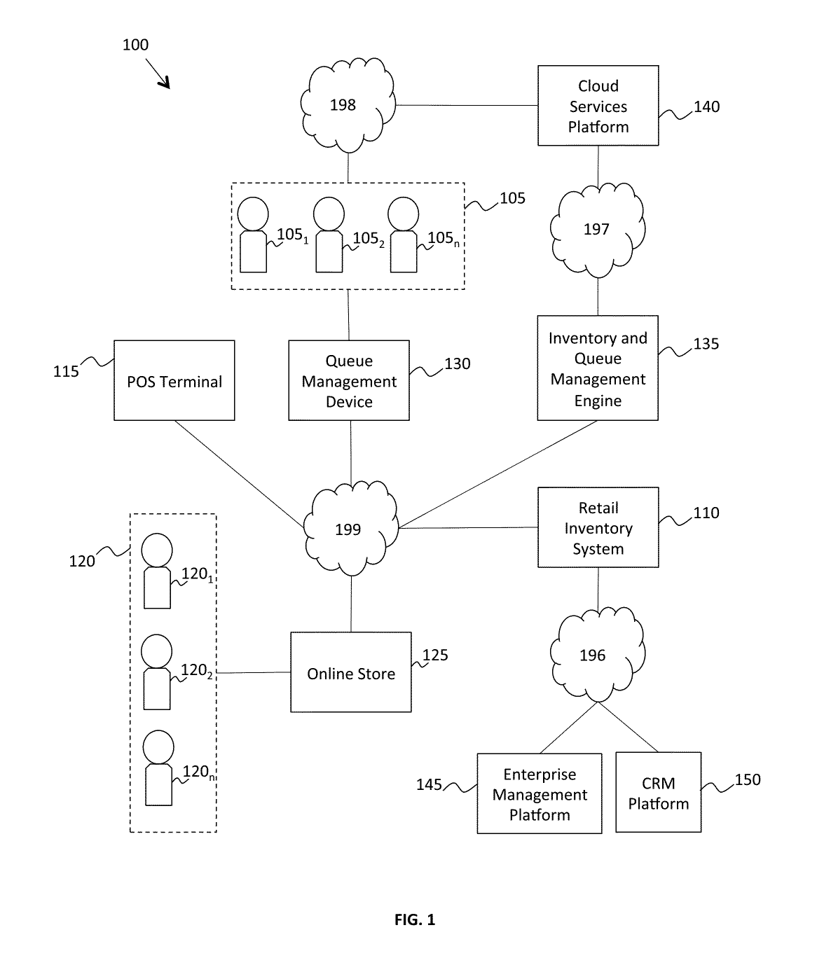

FIG. 1 illustrates an example of a system 100 for managing a queue and managing an inventory according to some embodiments of the present technology. The system 100 involves a retail inventory system 110 that can track inventory as purchases, returns, exchanges, and other transactions are conducted between a retailer and customers. For example, retail customers 105 (105₁, 105₂, . . . 105ₙ) can perform transactions with a retailer through a point-of-sale (POS) terminal 115 or using a payment application on a retail customer's electronic device. Likewise, online customers 120 (120₁, 120₂, . . . 120ₙ) can perform transactions (e.g. reserve online and pick up in store) through an online store 125.

These transactions can be tracked through the retail inventory system 110 to ensure that customers will receive the items that they anticipate receiving when they enter a queue in a retail store or reserve an item online. The online store 125 is operably coupled with the retail inventory system 110 through one or more networks 199 and online transactions from online customers 120 can be monitored using the retail inventory system 110.

The anticipated transactions of the retail customers 105 can also be monitored by the retail inventory system 110 using a queue management device 130 and an inventory and queue management engine (IQME) 135.

The queue management device 130 can comprise a portable electronic device operated by an employee of a retail store. The employee can survey the retail customers 105 and determine their contact information (e.g. cellular phone number) and information relating to desired products (e.g. new device, upgraded device, etc.) or services (device repair, technical support, etc.). An employee can manually enter the information into the queue management device 130 and send the information to the IQME 135 through one or more networks 199. Also, the queue management device 130 and a device operated by a retail customer 105 can wirelessly (e.g. via near field communications) exchange information relating to the retail customer's 105 contact information, hardware profile, etc. and send the information to the IQME 135 through one or more networks 199.

In some embodiments, a retail customer 105 can communicate with a cloud resource platform 140 via one or more network 198. The retail customer can have an account and with a cloud services platform 140 and can have an account identifier that identifies the retail customer 105. The retail customer 105 can communicate the account identifier to the IQME 135 through the cloud services platform via one or more network 197.

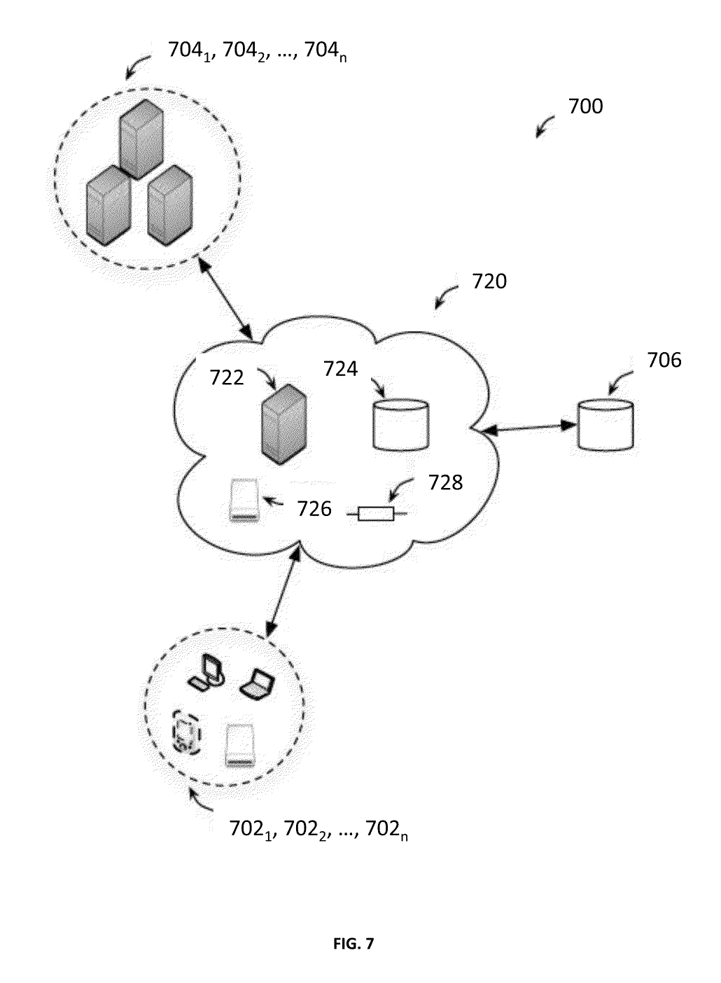

Cloud computing is a type of Internet-based computing in which a variety of resources are hosted and/or controlled by an entity and made available by the entity to authorized users via the Internet, as explained in greater detail with reference to FIG. 7 below.

The IQME 135 can also receive information, orders, reservations, etc. from online costumers 120. When the IQME 135 receives retail customers' 105 and/or online customer's 120 information, the IQME 135 can create a reservation for inventory in the retail inventory system 110 and the IQME 135 can send the customers with information about their position in a queue and tools for expediting a transaction. For example, the IQME 135 can send customers an executable link and/ or instructions for accessing a graphical user interface (GUI) with a digital queue card and expediting tools.

The digital queue can inform a customer about their respective position in a queue. For example, a digital queue card and include information about the customers' position in the queue, their queue group, an estimated wait time, etc. Also, the IQME 135 can send notifications, updates, etc. For example, if estimated wait time change (e.g. due to increased efficiency by customers using expediting tools), the IQME 135 can notify the customers that their wait time has shortened. Sharing customer contact information, sending notifications to customers, etc. can be subject to an opt-in policy and/ or other privacy policy, as explained in greater detail below.

In some embodiments of the present technology, the retail inventory system 110 is also operatively coupled with an enterprise management platform 145 and a customer relationship management (CRM) platform 150 via one or more networks 196. The networks 199, 198, 197, and 196 can be the same or different networks.

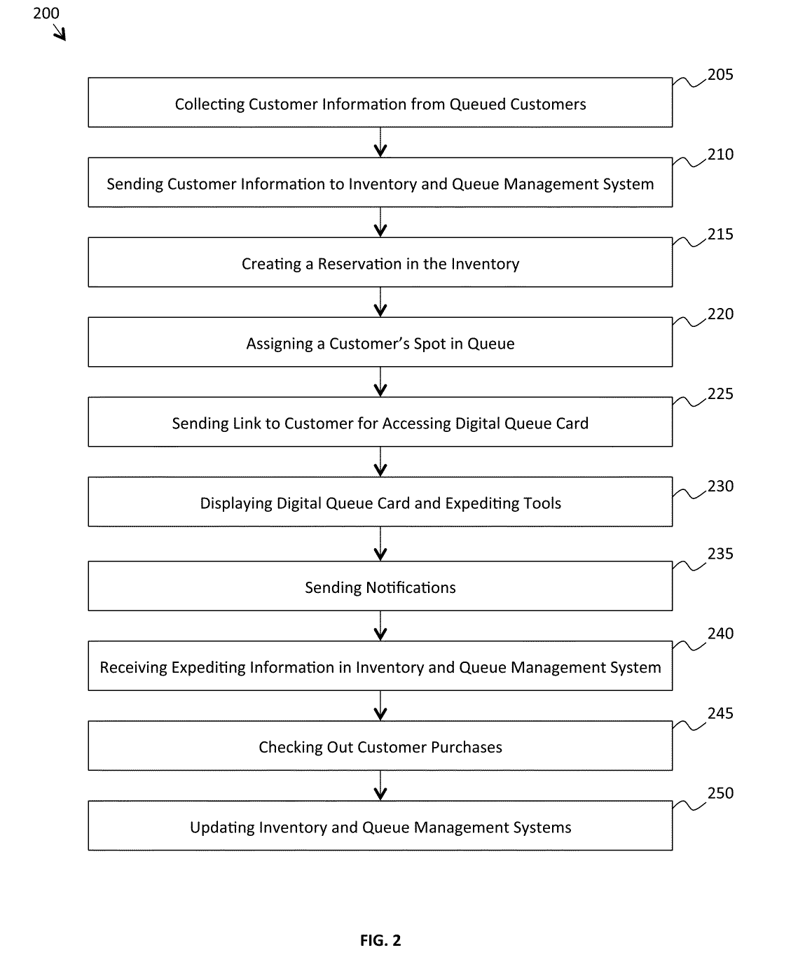

FIG. 2 illustrates an example of a method 200 of managing a queue and managing an inventory system according to some embodiments of the present technology. First, the method 200 involves collecting customer information from queued up customers 205. For example, during a new product launch event, a retail store employee can collect customer information from queued-up customers using a portable electronic device with a queue management application installed thereon.

For example, the employee can gather: product information for creating a reservation for an inventory item (e.g. desired product); identification information (e.g. customer name, queue position) for assigning the customer a spot in a digital queue; and contact information (e.g. cellular phone number) for sending the customer information about the queue, product, launch event, promotional content, etc.

Next, once customer information is collected, the method 200 can involve sending the customer information to an inventory and queue management system 210. Once the inventory and queue management system receives customer information, the method 200 can involve creating a reservation for a specified product in the retail location's inventory 215 and assigning the customer a spot in a digital queue 220.

Next, the method 200 can involve sending a link to the customer (e.g. sending an SMS message to a cellular number collected by the employee) for accessing a digital queue card 225. After a customer executes the link, the method 200 displays the digital queue card and expediting tools 230.

The digital queue card can include information about the products reserved for the customer, the customer's assigned position in the queue, an estimated wait time, etc. Also, the expediting tools can be used to speed up a transaction by allowing a customer to enter additional information about their transaction before getting to the point-of-sale. For example, the expediting tools can include tools for entering an account identifier, cellular network data for checking the eligibility of a product for a particular carrier, information about reusing or recycling an existing product, backing up existing product, etc.

Similarly, the expediting tools can influence the collective speed of the queue. For example, if many customers in the queue use the expediting tools, the wait time for everyone will decrease significantly. In this case, the inventory and queue management system can send updated estimated wait times to all of the digital queue cards. The method 200 involve sending notifications 235 to the customer with updates to the estimated wait time, news about a launch event, promotional items, etc. The notifications can be shown on the digital queue card, sent in an SMS message, displayed on a lock screen, etc.

The method 200 can involve receiving expediting information in the inventory and queue management system 240 for the customers in the queue, checking out customers' purchases 245, and updating the inventory and queue management system 250.

Some embodiments of the present technology involve additional tools for enabling the customer to pay while in line to further expedite their checkout process. The payment may either be done through self-payment or through assisted payment with an employee while in line outside of the store.

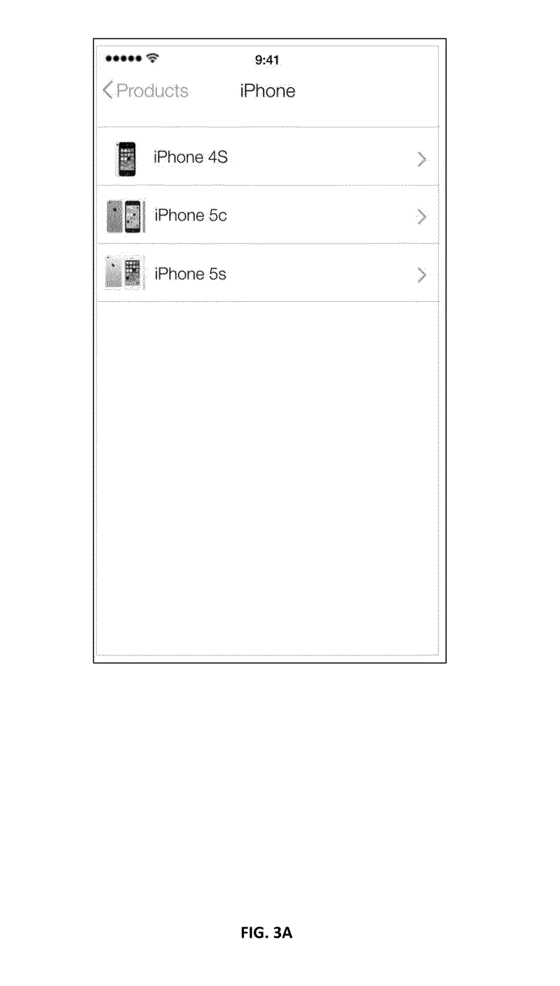

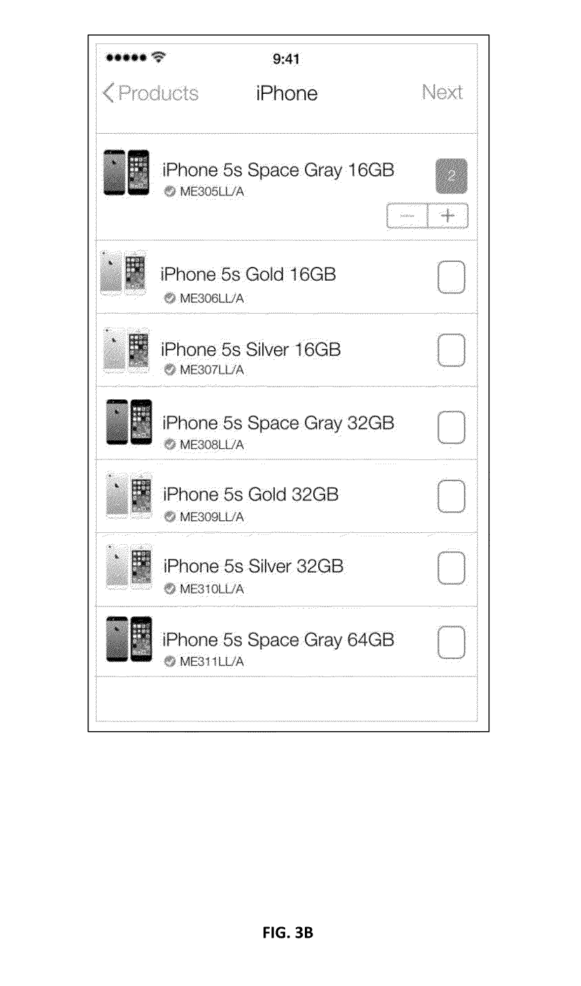

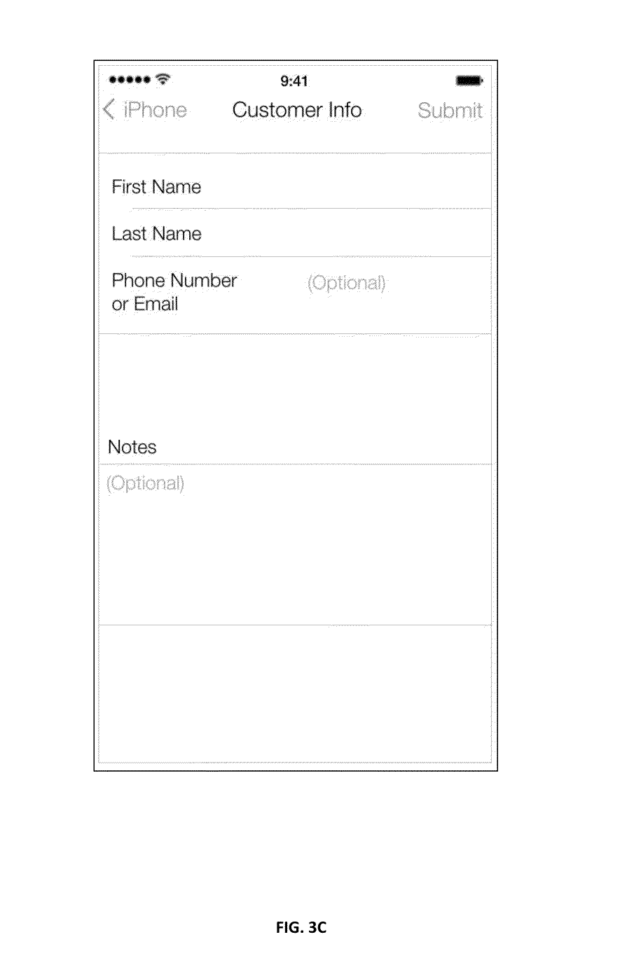

FIGS. 3A-3C illustrate examples of interface tools used by a queue management device to collect customer information, to send customer information to an inventory and queue management engine, and to create a reservation in a retail inventory system. In FIG. 3A, an employee can input a general description of a customer's desired product into the queue management device. Once the general description is entered, the employee can specify a particular quality of particular products using the interface tools of FIG. 3B. Once the customer's desired products are specified, the employee can use the interface tools of FIG. 3C to collect the customer's contact information. The queue management device can send the customer information and specified product information to retail inventory system to reserve the products for the customer. Likewise, the queue management device can send the customer information to an inventory and queue management engine for assigning the customer a spot in a queue and sending the customer a link for accessing a digital queue card and expediting tools.

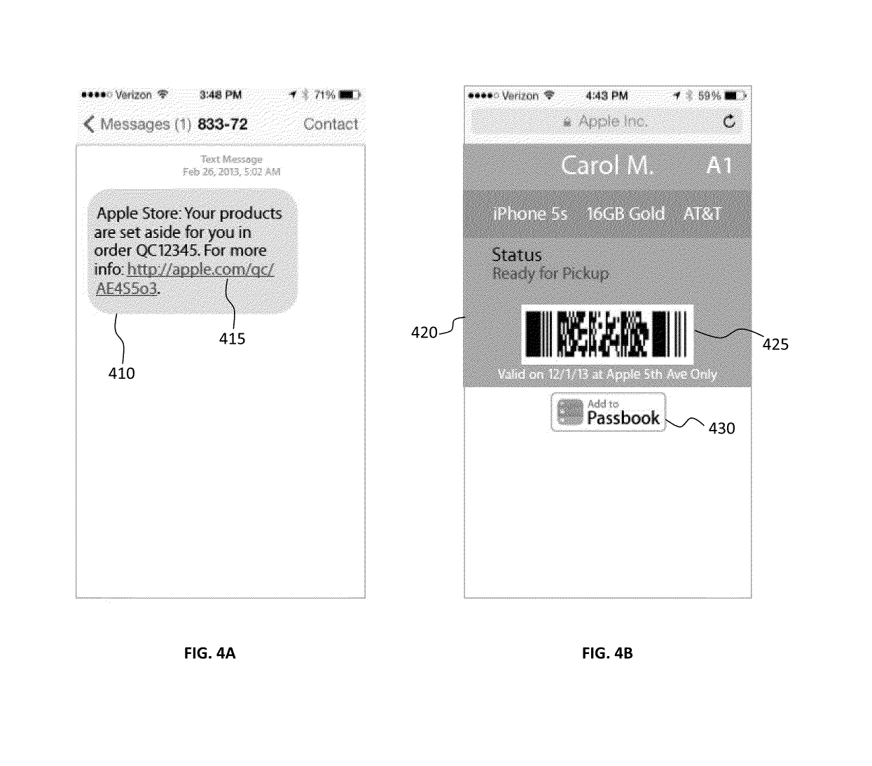

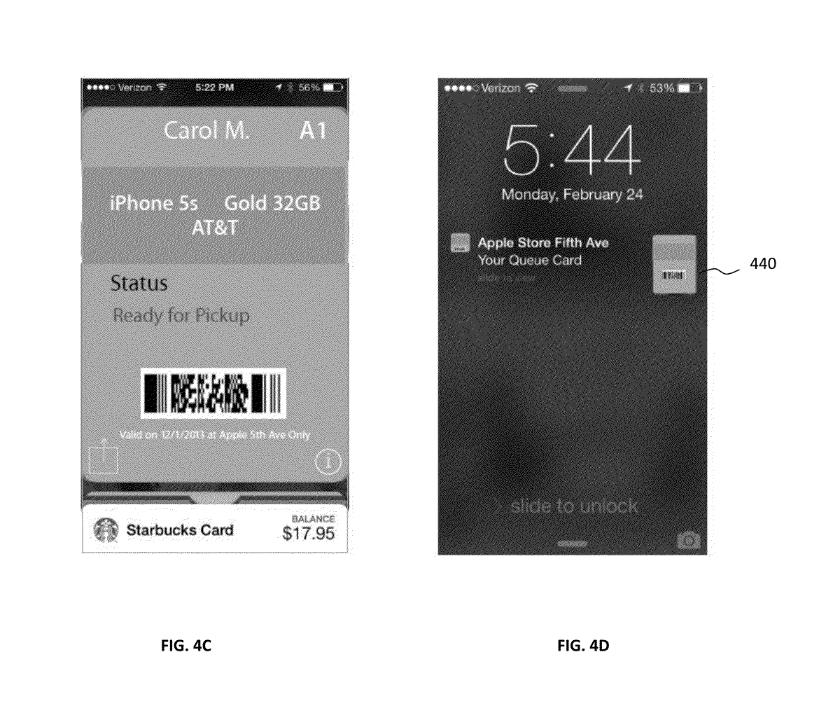

FIG. 4A illustrates a message 410 sent to a customer by an inventory and queue management engine according to some embodiments of the present technology. As shown, the message 410 explains that a reservation has been made and the customer-specified products have been set aside and cataloged with an order number. Also, the message 410 includes an executable link 415 for accessing a digital queue card and expediting tools. The link 415 can open a browser application for displaying the digital queue card. FIG. 4B illustrates an example of a browser-based digital queue card 420. The digital queue card 420 includes the customer's name, position in a queue, a description of the products specified by the customer, an inventory status, an identification of a particular retail location where the products are reserved, and a scanable code 425 that can be scanned by a retail device to locate the reserved products and perform a transaction. Also, the digital queue card 420 can include a button 430 for adding the digital queue card 420 to a digital wallet application.

FIG. 4C illustrates an example of a digital queue card 420 in a digital wallet application according to some embodiments of the present technology. The digital queue card 420 again includes the customer's name, position in a queue, a description of the products specified by the customer, an inventory status, and an identification of a particular retail location where the products are reserved. The digital queue card 420 can also display an estimated wait time based on the customer's spot in the queue and time it takes for the retail store to check out customers (aka checkout velocity). Also, the estimated checkout time can be displayed on the digital queue card and can be changed when customers use expediting tools, as will be explained in greater detail below.

In some embodiments, the digital queue card 420 can only be used to redeem reserved products at the particular retail location. This policy can be used to prevent joining a queue at one location and using the assigned queue position in another (e.g. longer) queue. In some embodiments of the present technology, a retail location can use a geo-fence to detect electronic devices (that have opted in to using location services) that contain a queue card for that particular retail location. In these cases, a notification 440 can automatically appear on the electronic device's lock screen when the device enters the geo-fence, as shown in FIG. 4D. However, sometimes a physical queue of customers at a particular retail location can be very long (e.g. during a launch event). Therefore, in some embodiments of the present technology, a cellular network can be used to detect devices that contain a queue card for that particular retail location when an in-store network (e.g. a wireless network) would not cast a wide enough geo-fence to detect customers in the back of the queue (e.g. blocks away).

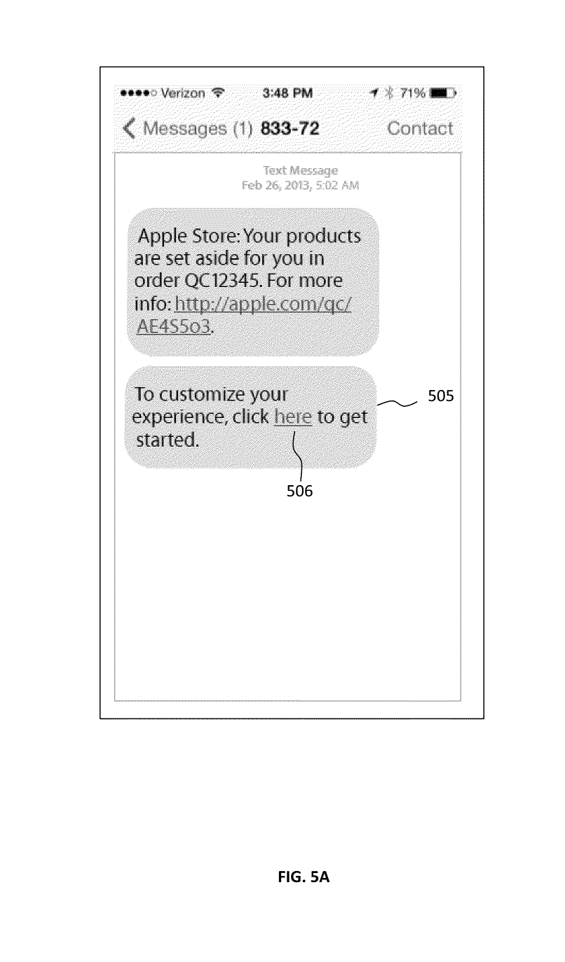

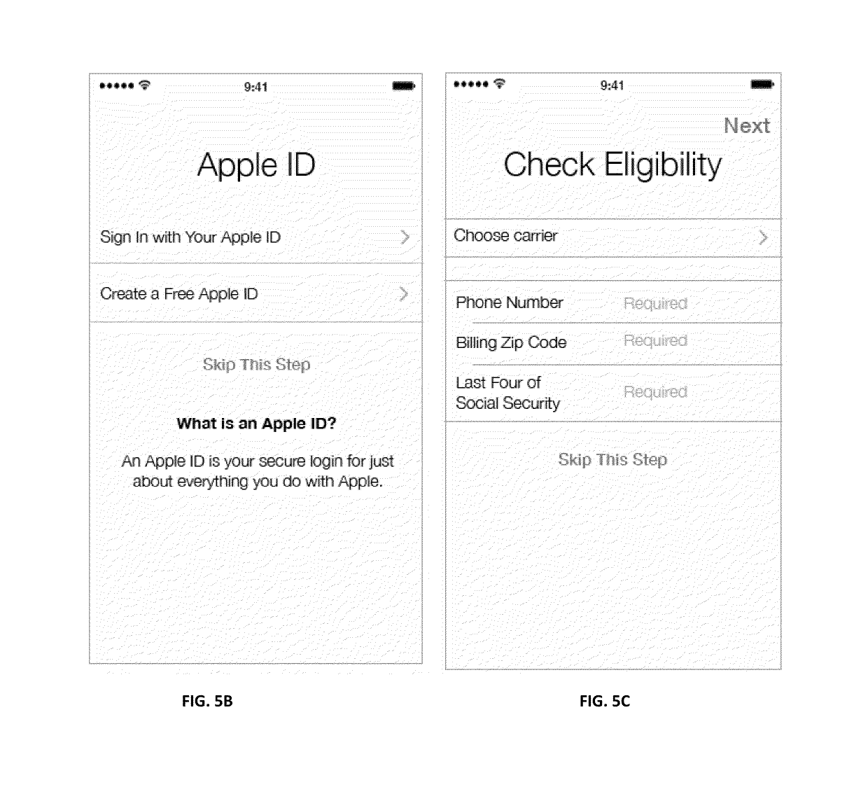

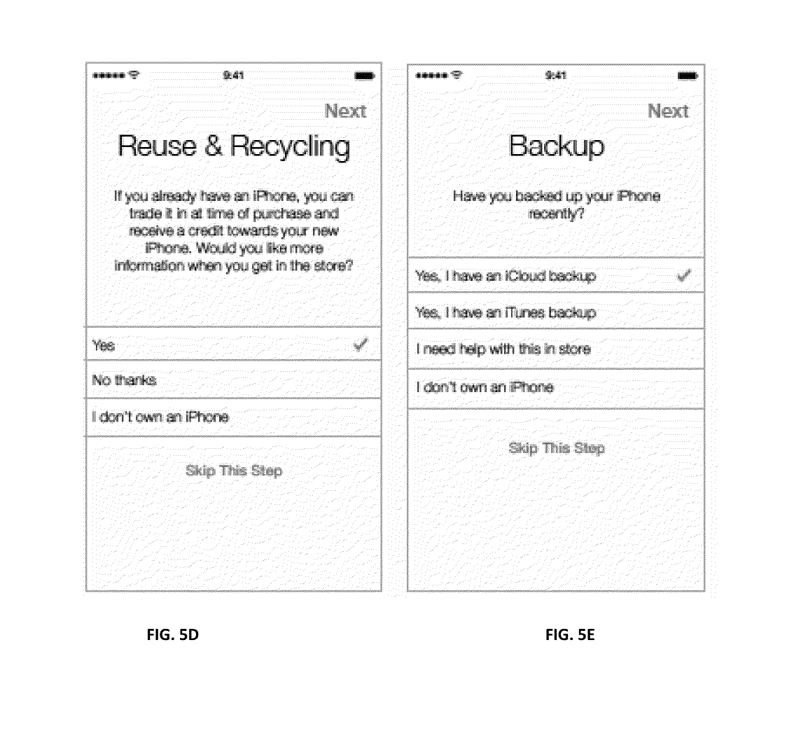

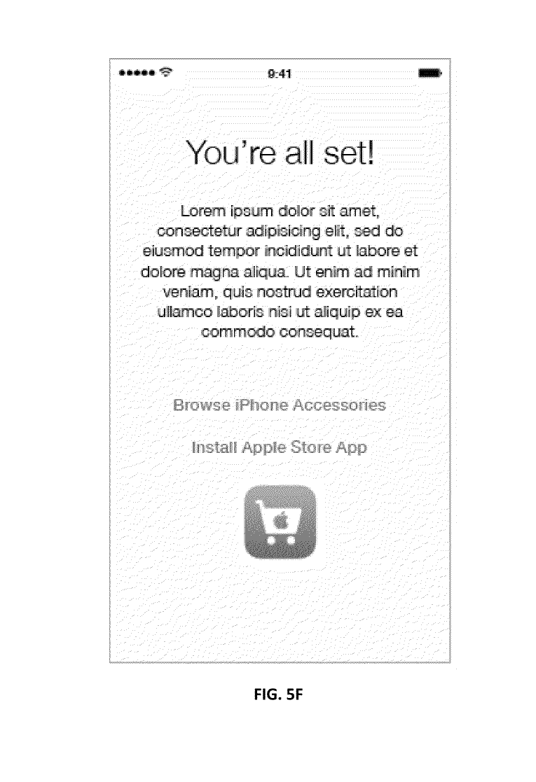

As explained above, an inventory and queue management engine can provide customers with expediting tools for expediting transactions in a retail store and for providing increased efficiency for both individual customers and decreased wait times for the collective group of customers in a queue. FIGS. 5A-5F illustrate examples of expediting tools according to some embodiments of the present technology.

In addition to or as alternative to a notification on a lock screen as shown in FIG. 4D, the inventory and queue management engine can send a notification to a customer after entering a pre-determined area (e.g. a geo-fence surrounding a retail location). FIG. 5A illustrates an example of a notification message 505 sent to a customer after entering a pre-determined area (e.g. a geo-fence surrounding a retail location). The notification message 505 provides an executable link 506 for accessing expediting tools. FIGS. 5B-5F illustrate examples of expediting tools according to some embodiments of the present technology.

In FIG. 5B, the expediting tools include fillable fields for signing in to an inventory and queue management engine using an account identifier and for creating an account. In FIG. 5C, the expediting tools include fillable fields for specifying a cellular carrier and cellular plan account information. These tools can be used to check the eligibility of a new product on the specified cellular carrier and to facilitate porting a phone number to a new device at the point-of-sale. In FIG. 5C, the expediting tools include options for trading in an existing device when purchasing a new device.

FIG. 5E illustrates an example of checkout expediting tools used to backup an existing device before purchasing a new device. In some cases, the expediting tools can allow a customer to backup their device using a cloud services platform. In FIG. 5F, the expediting tools include options for browsing other products that can used with the device specified product (e.g. compatible accessories) and for installing additional software that can facilitate checkout (e.g. a self checkout application). The expediting tools can also allow the customer to specify whether they will be paying with cash or credit.

In some embodiments, the estimated wait time for each customer on the list depends on the customer's queue position number and a checkout velocity. The checkout velocity can be initialized as an estimate based on past data and can be adjusted as customers check out to reflect actual checkout times. Also, the checkout velocity variable can be decreases as customers provide expediting information. In some embodiments of the present technology, the use of expediting tools can be gamified and/or incentivized by providing promotions, media content, infotainment, etc. to customers who successfully complete expediting steps. The system can continuously estimate wait times for customers in the queue based on the number of people in the queue and the estimated checkout time. Also, the estimated waiting time drops for all customers every time a customer uses the expediting tools to reduce his individual checkout time drops thereby providing benefit to himself and to all the other customers in the queue.

In addition to expediting tools, the inventory and queue management engine can send out other types of notifications to customers in a queue. For example, the inventory and queue management engine can send customers a notification when their spot in the queue is near, when their queue group is being called, when their spot in the queue is close (e.g. ten minutes), etc.

Also, changes in the estimated wait time can be sent to customers. As customers in the queue utilize the expediting tools, the time it takes to conduct transactions with those users decreases. Consequently, the estimated wait time for the rest of the customers in the queue will decrease. In some cases, the estimated wait time is continuously being calculated and only changes of a threshold time (e.g. fifteen minutes) are sent as notifications. In some other cases, the decision to report the changes in estimated wait time depends on the wait time itself for each particular customer. For example, only large changes in estimated wait time (e.g. thirty minutes) are sent to customers at the end of a long queue while smaller changes in estimated wait time (e.g. five minutes) are sent to customers near the front of the queue.

Also, during some retail events (e.g. product launches, midnight releases, etc.) the inventory and queue management engine can provide notifications or other content to customers in the queue. For example, during a launch event the CEO of the retailer or product manufacturer can send a message to customers waiting in line to thank them for their loyalty and patience. Also, in advance of a midnight launch, preview or sneak-peak content can be delivered to customers in the queue.

When a customer's reaches the front of the queue or the customer's group number is called, the retail store employee can perform the checkout process for the customer. The employee can simply look up the customer by name or the employee can use a queue management device or other point of sale device to scan the customer's digital queue card and access the reservation in the inventory system. Also, the employee can browse the digital queue to view a list of customers and which customer is next in the queue.

The queue management device or other point of sale device can include tools for managing inventory as customers check out. For example, if the next customer in the queue is present, the employee can use the tools to send a message to the retail back of house to retrieve the reserved products. If the next customer in the queue is not present, the employee can use the tools to send a message to the retail back of house to set aside the reserved products.

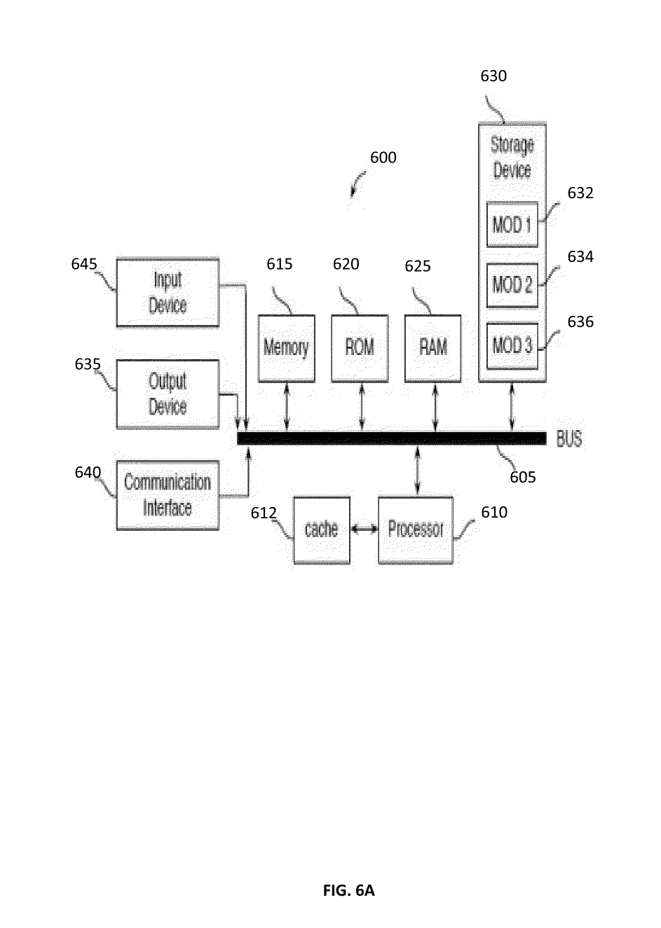

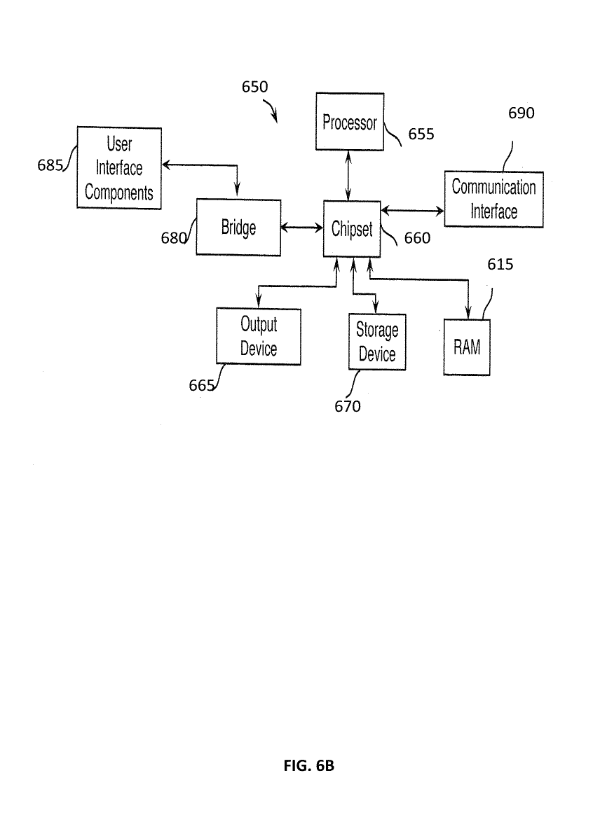

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

As explained above, cloud computing is a type of Internet-based computing in which a variety of resources are hosted and/or controlled by an entity and made available by the entity to authorized users via the Internet. An exemplary cloud computing system configuration 700 is illustrated in FIG. 7 wherein a variety of electronic devices can communicate via a network for purposes of exchanging content and other data. The system can be configured for use on a wide variety of network configurations that facilitate the intercommunication of electronic devices. For example, each of the components of system 700 in FIG. 7 can be implemented in a localized or distributed fashion in a network.

System 700 can be configured to include cloud computing resources 720. The cloud resources can include a variety hardware and/or software resources, such as cloud servers 722, cloud databases 724, cloud storage 726, cloud networks 728, cloud applications, cloud platforms, and/or any other cloud-based resources. In some cases, the cloud resources are distributed. For example, cloud storage 726 can include multiple storage devices. In some cases, cloud resources can be distributed across multiple cloud computing systems and/or individual network enabled computing devices. For example, cloud computing resources 720 can communicate with servers 704₁, 704₂, . . . , 704ₙ (collectively “704”), database 706, and/or any other network enabled computing device to provide the cloud resources.

Furthermore, in some cases, the cloud resources can be redundant. For example, if cloud computing resources 720 is configured to provide data backup services, multiple copies of the data can be stored such that if one storage resource is unavailable the data will still be available to the user. In another example, if cloud computing resources 720 are configured to provide software, the software can be available from different cloud servers so that the software can be served from the closest server.

In system 700, a user interacts with the cloud computing resources 720 through user terminals 702₁, 702₂, . . . , 702ₙ (collectively “702”) connected to a network by direct and/or indirect communication. Cloud computing resources 720 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 720 can concurrently accept connections from and interact with multiple electronic devices.

Cloud computing resources 720 can provide cloud resources through a variety of deployment models, such as public, private, community, hybrid, and/or any other cloud deployment model. In some cases, cloud computing resources 720 can support multiple deployment models. For example, cloud computing resources 720 can provide one set of resources through a public deployment model and another set of resources through a private deployment model.

In some configurations, a user terminal 702, can access cloud computing resources 720 from any location where an Internet location is available. However, in other cases, cloud computing resources 720 can be configured to restrict access to certain resources such that a resource can only be accessed from certain locations. For example, if cloud computing resources 720 is configured to provide a resource using a private deployment model, then cloud computing resources 720 can restrict access to the resource, such as by requiring that a user terminal 702ᵢ access the resource from behind a firewall.

Cloud computing resources 720 can provide cloud resources to user terminals 702 through a variety of service models, such as Software as a Service (SaaS), Platforms as a service (PaaS), Infrastructure as a Service (IaaS), and/or any other cloud service models. In some cases, cloud computing resources 720 can provide multiple service models to a user terminal 702ᵢ. For example, cloud computing resources 720 can provide both SaaS and IaaS to a user terminal 702ᵢ. In some cases, cloud computing resources 720 can provide different service models to different user terminals 702. For example, cloud computing resources 720 can provide SaaS to user terminal 702₁ and PaaS to user terminal 702₂.

In some cases, cloud computing resources 720 can maintain an account database. The account database can store profile information for registered users. The profile information can include resource access rights, such as software the user is permitted to user, maximum storage space, etc. The profile information can also include usage information, such as computing resources consumed, data storage location, security settings, personal configuration settings, etc.

Cloud computing resources 720 can provide a variety of functionality that requires user interaction. Accordingly, a user interface (UI) can be provided for communicating with cloud computing resources 720 and/or performing tasks associated with the cloud resources. The UI can be accessed via an end user terminal 702, in communication with cloud computing resources 720. The UI can be configured to operate in a variety of client modes, including a fat client mode, a thin client mode, or a hybrid client mode, depending on the storage and processing capabilities of cloud computing resources 720 and/or the user terminal 702ᵢ. Therefore, a UI can be implemented as a standalone application operating at the user terminal in some embodiments. In other embodiments, a web browser-based portal can be used to provide the UI. Any other configuration to access cloud computing resources 720 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are generally recognized meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
calculating an estimated wait time for customers in a queue with a group of customers;
receiving customer information from the customer, the customer information specifying a product for sale in a retail store;
sending the customer information to an inventory and queue management (IQM) system of the retail store;
creating, in the IQM system, a reservation for the specified product for the customer;
assigning, in the IQM system, a spot for the customer in the queue;
sending a link to the customer for accessing a queue management interface containing a code for accessing the reservation at a point of sale and checkout expediting tools;
receiving checkout expediting information from the customer; and
updating the estimated wait times for the group of customers to reflect an effect of the checkout expediting information received from the customer.

2. The computer-implemented method of claim 1, further comprising:
assigning the customer a queue position number, wherein the estimated wait time for each customer on the list depends on the customer's queue position number and a checkout velocity in the retail store.

3. The computer-implemented method of claim 2, wherein the checkout velocity is decreased in response to receiving the checkout expediting information.

4. The computer-implemented method of claim 3, further comprising:
transmitting a notification to one or more of the customers in the group of customers that the estimated wait times have been decreased.

5. The computer-implemented method of claim 1, further comprising:
sending a promotional media item to a customer in response to receiving expediting information from the customer.

6. The computer-implemented method of claim 1, wherein the checkout expediting tools include a link to a network storage platform for backing up data on an electronic device.

7. A system comprising:
a queue management device configured to gather customer information from a customer in a queue of customers and transmit the customer information, the customer information specifying a product for sale in a retail store;
an inventory and queue management (IQM) system configured to receive the customer information, create a reservation for the specified product for the customer, assign a spot for the customer in the queue, send a link to the customer for accessing a queue management interface containing a code for accessing the reservation at a point of sale and checkout expediting tools, and receive checkout expediting information from the customer.

8. The system of claim 7, wherein IQM system is further configured to estimate the wait time for the customer in the queue and update the estimated wait times for the queue of customers to reflect an effect of the checkout expediting information received from the customer.

9. The system of claim 8, wherein the IQM system is further configured to transmit a notification to one or more of the customers in the queue of customers that the estimated wait times have been decreased.

10. The system of claim 7, wherein IQM system is further configured to send a promotional media item to a customer in response to receiving expediting information from the customer.

11. The system of claim 7, wherein the checkout expediting tools include a link to a network storage platform for backing up data on an electronic device.

12. A non-transitory computer-readable storage medium comprising:
a medium configured to store computer-readable instructions thereon; and
the computer-readable instructions that, when executed by a processing device cause the processing device to perform a method, comprising:
calculating an estimated wait time for customers in a queue with a group of customers;
receiving customer information from the customer, the customer information specifying a product for sale in a retail store;
sending the customer information to an inventory and queue management (IQM) system of the retail store;
creating, in the IQM system, a reservation for the specified product for the customer;
assigning, in the IQM system, a spot for the customer in the queue;
sending a link to the customer for accessing a queue management interface containing a code for accessing the reservation at a point of sale and checkout expediting tools;
receiving checkout expediting information from the customer; and
updating the estimated wait times for the group of customers to reflect an effect of the checkout expediting information received from the customer.

13. The non-transitory computer-readable storage medium of claim 12, the instructions further causing the processing device to perform the step of:
assigning the customer a queue position number, wherein the estimated wait time for each customer on the list depends on the customer's queue position number and a checkout velocity in the retail store.

14. The non-transitory computer-readable storage medium of claim 13, wherein the checkout velocity is decreased in response to receiving the checkout expediting information.

15. The non-transitory computer-readable storage medium of claim 14, the instructions further causing the processing device to perform the step of:
transmitting a notification to one or more of the customers in the group of customers that the estimated wait times have been decreased.

16. The non-transitory computer-readable storage medium of claim 12, the instructions further causing the processing device to perform the step of:
sending a promotional media item to a customer in response to receiving expediting information from the customer.

17. The non-transitory computer-readable storage medium of claim 12, wherein the checkout expediting tools include a link to a network storage platform for backing up data on an electronic device.

18. A computer-implemented method comprising:
receiving customer information from a customer in a queue, the customer information specifying the customer's invention to replace an existing electronic device with a new electronic device for sale in a retail store;
sending the customer information to an inventory and queue management (IQM) system of the retail store;
creating, in the IQM system, a reservation for the specified product for the customer; and
sending to the customer a code for accessing the reservation and a link to a network storage platform for backing up data on the existing electronic device.

19. The computer-implemented method of claim 18, further comprising:
assigning, in the IQM system, a queue for the customer
calculating an estimated wait time for the customer, wherein the estimated wait time for each customer on the list depends on the customer's queue position number and a checkout velocity in the retail store,
wherein the code further comprises checkout expediting tools for allowing the customer to send the IQM system checkout expediting information, wherein the checkout velocity is decreased in response to receiving the checkout expediting information.

20. The computer-implemented method of claim 19, further comprising:
sending a promotional media item to the customer in response to receiving expediting information from the customer.
